(19) United States
(12) Patent Application Publication
(10) Pub. No.: US 2014/0281916 A1
(43) Pub. Date: Sep. 18, 2014

(54) Supporting Font Character Kerning

(71) Applicant: Monotype Imaging Inc., Woburn, MA (US)

(72) Inventors: Sampo Juhani Kaasila, Plaistow, NH (US); Anand Vijay, Madhya Pradesh (IN); Jitendra Kumar Bansal, Rajasthan (IN)

(21) Appl. No.: 14/208,951

(22) Filed: Mar. 13, 2014

Related U.S. Application Data
(60) Provisional application No. 61/787,760, filed on Mar. 15, 2013.

(51) Int. Cl. G06F 17/21

(52) U.S. Cl. CPC G06F 17/214
USPC 715/234

(57) ABSTRACT

A system includes a computing device that includes a memory configured to store instructions. The computing device also includes a processor to execute the instructions to perform operations that include receiving information that identifies an asset presenter being executed by a computing device. Based on the identity of the asset presenter, operations include determining whether the asset presenter is capable of adjusting the spacing between adjacent font characters present in content of an asset provided across one or more networks. In response to the determination, operations include sending font information to the computing device to allow the spacing of the adjacent font characters present in the content of the asset to be adjusted for presentation by the computing device.

### CLAIM OF PRIORITY

This application claims priority under 35 USC §119(e) to U.S. Patent Application Ser. No. 61/787,760, filed on Mar. 15, 2013, the entire contents of which are hereby incorporated by reference.

### BACKGROUND

This description relates to techniques for allowing computing devices to support kerning for presenting font characters.

In the ever-expanding connectivity and information sharing capabilities provided by computer networks such as the Internet, various types of web assets such as websites, webpages, etc. have been developed to assist with the transfer of information. Along with the almost explosive development of web assets, the content being presented by the assets has similarly grown. Text, audio, video, etc. is being incorporated into web assets to provide a more efficient and enjoyable viewing experience. For example, different languages, imagery, etc. may be included in web assets to tailor content for characteristics of a viewer such as their geographical location. However, providing such rich content does not come without some constraints. For example, the functionality of computing devices, operating systems, software, etc. may limit a viewer's ability to view and enjoy all of the content types that could be provided.

### SUMMARY

The systems and techniques described here relate to providing an asset presenter (e.g., a web browser, a device, etc.) with information to allow kerning of font characters to be supported by the asset presenter. Additionally, in some arrangements, a query may be executed to identify the asset presenter, determine if the asset presenter is capable of supporting font character kerning, etc. Based upon the identification, determination, etc. appropriate action may be taken. For example, if identified or determined that the asset presenter is capable of supporting character kerning, appropriate font information may be provided to the asset presenter. If not supported by the asset presenter, font information to address the situation may be prepared and provided such that the asset presenter can present font characters with appropriate kerning. By providing the ability to present appropriately spaced font characters by providing kerning information, viewer experiences may be improved along with their interest in the asset (e.g., webpage, website, etc.) being presented.

In one aspect, a computer-implemented method includes receiving information that identifies an asset presenter being executed by a computing device. Based on the identity of the asset presenter, the method also includes determining whether the asset presenter is capable of adjusting the spacing between adjacent font characters present in content of an asset provided across one or more networks. In response to the determination, the method includes sending font information to the computing device to allow the spacing of the adjacent font characters present in the content of the asset to be adjusted for presentation by the computing device.

Implementations may include one or more of the following features. The determination may be based upon information about the asset presenter accessed from a database, a comparison using a content presentation produced by the asset presenter, a comparison of a content presentation produced by the asset presenter and a content presentation produced by a font service provider, etc. Sending font information may include sending a font file to the computing device. Sending font information may include modifying a font file prior to sending the modified font file to the computing device. Modifying the font file may include removing a portion of the font file. Modifying the font file may include removing a portion of a table from the font file. Modifying the font file may include removing a portion of one of a kerning table and a glyph positioning table. Sending the font information may include sending a file executable by the asset presenter that contains instructions for adjusting the spacing between the adjacent font characters present in content of the asset. The executable filed may be produced by a font service provider. The font information sent to the computing device to allow the spacing of the font characters present in the content of the asset to be adjusted may be extracted by a font service provider. The sent font information may include one or more operations with information that identify font characters present in the content of the asset. The sent font information may include one or more operations associated with groups of font characters having similar geometry. The asset presenter may include one of a web browser, a web-based application and a web view application.

In another aspect, a system includes a computing device that includes a memory configured to store instructions. The computing device also includes a processor to execute the instructions to perform operations that include receiving information that identifies an asset presenter being executed by a computing device. Based on the identity of the asset presenter, operations include determining whether the asset presenter is capable of adjusting the spacing between adjacent font characters present in content of an asset provided across one or more networks. In response to the determination, operations include sending font information to the computing device to allow the spacing of the adjacent font characters present in the content of the asset to be adjusted for presentation by the computing device.

Implementations may include one or more of the following features. The determination may be based upon information about the asset presenter accessed from a database, a comparison using a content presentation produced by the asset presenter, a comparison of a content presentation produced by the asset presenter and a content presentation produced by a font service provider, etc. Sending font information may include sending a font file to the computing device. Sending font information may include modifying a font file prior to sending the modified font file to the computing device. Modifying the font file may include removing a portion of the font file. Modifying the font file may include removing a portion of a table from the font file. Modifying the font file may include removing a portion of one of a kerning table and a glyph positioning table. Sending the font information may include sending a file executable by the asset presenter that contains instructions for adjusting the spacing between the adjacent font characters present in content of the asset. The executable filed may be produced by a font service provider. The font information sent to the computing device to allow the spacing of the font characters present in the content of the asset to be adjusted may be extracted by a font service provider. The sent font information may include one or more operations with information that identify font characters present in the content of the asset. The sent font information may include one or more operations associated with groups of font characters having similar geometry. The asset presenter may include one of a web browser, a web-based application and a web view application.

In another aspect, one or more computer readable media storing instructions are executable by a processing device, and upon such execution cause the processing device to perform operations that include receiving information that identifies an asset presenter being executed by a computing device. Based on the identity of the asset presenter, operations include determining whether the asset presenter is capable of adjusting the spacing between adjacent font characters present in content of an asset provided across one or more networks. In response to the determination, operations include sending font information to the computing device to allow the spacing of the adjacent font characters present in the content of the asset to be adjusted for presentation by the computing device.

Implementations may include one or more of the following features. The determination may be based upon information about the asset presenter accessed from a database, a comparison using a content presentation produced by the asset presenter, a comparison of a content presentation produced by the asset presenter and a content presentation produced by a font service provider, etc. Sending font information may include sending a font file to the computing device. Sending font information may include modifying a font file prior to sending the modified font file to the computing device. Modifying the font file may include removing a portion of the font file. Modifying the font file may include removing a portion of a table from the font file. Modifying the font file may include removing a portion of one of a kerning table and a glyph positioning table. Sending the font information may include sending a file executable by the asset presenter that contains instructions for adjusting the spacing between the adjacent font characters present in content of the asset. The executable filed may be produced by a font service provider. The font information sent to the computing device to allow the spacing of the font characters present in the content of the asset to be adjusted may be extracted by a font service provider. The sent font information may include one or more operations with information that identify font characters present in the content of the asset. The sent font information may include one or more operations associated with groups of font characters having similar geometry. The asset presenter may include one of a web browser, a web-based application and a web view application.

In another aspect, a computer-implemented method includes receiving information that represents font characters and spacing of adjacent font characters. The method also includes extracting the information that represents the spacing of the adjacent font characters from the received information. The method also includes using the extracted information to produce an executable file that contains instructions for adjusting the spacing between adjacent font characters present in content of an asset, and, sending the executable file to a computing device for spacing the adjacent font characters of the asset content for presentation by the computing device.

Implementations may include one or more of the following features. The executable filed may be produced by a font service provider. The information may be extracted from a kerning table or a glyph positioning table. Sending font information may include modifying a font file prior to sending the modified font file to the computing device. Modifying the font file may include removing a portion of the font file. Modifying the font file may include removing a portion of a table from the font file. Modifying the font file may include removing a portion of one of a kerning table and a glyph positioning table. The sent font information may include one or more operations with information that identify font characters present in the content of the asset. The sent font information may include one or more operations associated with groups of font characters having similar geometry. The asset presenter may include one of a web browser, a web-based application and a web view application.

In another aspect, a system includes a computing device that includes a memory configured to store instructions. The computing device also includes a processor to execute the instructions to perform operations that include receiving information that represents font characters and spacing of adjacent font characters. Operations also include extracting the information that represents the spacing of the adjacent font characters from the received information. Operations also include using the extracted information to produce an executable file that contains instructions for adjusting the spacing between adjacent font characters present in content of an asset, and, sending the executable file to a computing device for spacing the adjacent font characters of the asset content for presentation by the computing device.

Implementations may include one or more of the following features. The executable filed may be produced by a font service provider. The information may be extracted from a kerning table or a glyph positioning table. Sending font information may include modifying a font file prior to sending the modified font file to the computing device. Modifying the font file may include removing a portion of the font file. Modifying the font file may include removing a portion of a table from the font file. Modifying the font file may include removing a portion of one of a kerning table and a glyph positioning table. The sent font information may include one or more operations with information that identify font characters present in the content of the asset. The sent font information may include one or more operations associated with groups of font characters having similar geometry. The asset presenter may include one of a web browser, a web-based application and a web view application.

In another aspect, one or more computer readable media storing instructions are executable by a processing device, and upon such execution cause the processing device to perform operations that include receiving information that represents font characters and spacing of adjacent font characters. Operations also include extracting the information that represents the spacing of the adjacent font characters from the received information. Operations also include using the extracted information to produce an executable file that contains instructions for adjusting the spacing between adjacent font characters present in content of an asset, and, sending the executable file to a computing device for spacing the adjacent font characters of the asset content for presentation by the computing device.

Implementations may include one or more of the following features. The executable filed may be produced by a font service provider. The information may be extracted from a kerning table or a glyph positioning table. Sending font information may include modifying a font file prior to sending the modified font file to the computing device. Modifying the font file may include removing a portion of the font file. Modifying the font file may include removing a portion of a table from the font file. Modifying the font file may include removing a portion of one of a kerning table and a glyph positioning table. The sent font information may include one or more operations with information that identify font characters present in the content of the asset. The sent font information may include one or more operations associated with groups of font characters having similar geometry. The asset presenter may include one of a web browser, a web-based application and a web view application.

These and other aspects and features and various combinations of them may be expressed as methods, apparatus, systems, means for performing functions, program products, and in other ways.

Other features and advantages will be apparent from the description and the claims.

### DESCRIPTION OF DRAWINGS

FIG. 1 illustrates a mobile device presenting text.

FIG. 2 is a block diagram of an Internet based computer network.

FIG. 3 illustrates a font service provider for distributing font information to computing devices.

FIG. 4 illustrates grouping of font characters into classes.

FIGS. 5a and b are example flow charts of operations of a font service manager.

FIG. 6 is a block diagram showing an example of a system for providing hosted storage and accessing the hosted storage from a client device.

FIG. 7 illustrates an example of a computing device and a mobile computing device that can be used to implement the techniques described here.

### DETAILED DESCRIPTION

Referring to FIG. 1, many types of computing devices are capable of presenting various types of graphical content such as text, images, video, etc. To present text and similar graphics, various types of font families (e.g., Times New Roman, Arial, etc.) may be used that typically include a set of fonts, e.g., regular, italic, bold, bold italic, etc. Each font generally includes a set of individual character shapes called glyphs and the glyphs generally share various design features (e.g., geometry, stroke thickness, serifs, size, etc.) associated with the font. One or more techniques may be utilized for representing such fonts; for example, outline-based representations may be adopted in which lines and curves are used to define the borders of glyphs. Such fonts may be scalable for a variety of sizes (e.g., for rending by various computing devices) and may be represented in one or more formats. For example, scalable outline fonts may be represented in a format that includes data structures capable of supporting a variety of typographic visual symbols of many languages. Along with the size and shape of the glyphs used by the font to represent a character, the spacing between individual characters may be adjusted to provide a pleasant visual appearance to the viewer. For example, the spacing of adjacent individual characters may be adjusted in a process referred to as kerning. In general, the kerning process addresses characters of fonts that contain glyphs of varying widths (e.g., referred to as proportional fonts) and adjusts the spacing of adjacent character pairs as they appear in the text of an asset.

As illustrated in the figure, some devices, operating systems, software applications etc. may be capable of presenting font characters. However, often such devices, operating systems, applications, etc. may be unable to support appropriate kerning when presenting the font characters. For example, absent the ability to adjust spacing based upon the shapes of adjacent characters, no kerning may be applied and alternate techniques may be implemented (e.g., a uniform spacing may be used for separating all character pairs). In this illustrated example, a cellular telephone 100 is executing an asset presenter (e.g., web browser application 102) to present content transmitted over one or more networks (e.g., the Internet) from a variety of sources. In this situation, the web browser 102 does not support the ability of kerning adjacent pairs of characters included in the content. For example, the presented pair of characters “A” 106 and “V” 108 may be separated by a fixed spacing that does not account for the shaping of the two individual characters. Alternatively, if the web browser 102 is capable of supporting the kerning of characters, a more visually pleasing representation of the characters may be presented. For example, a representation 108 of the letters presented without kerning illustrates that the complementary shapes of the two letters “A” and “V” are not utilized and the spacing of the two letters does not allow for overlap (as indicated by a dashed line 110). Alternatively, by employing a kerning process, the complementing shapes of the two letters can be exploited to produce a representation in which the separation between the two characters has been reduced (as indicated by a dashed line 110) or increased (as needed) and that provides a more pleasing visual appearance of the two adjacent characters for this font.

Referring to FIG. 2, a computing environment 200 includes components for assisting devices to employ kerning in presenting web assets (e.g., a website, webpage, etc.). In this example, a computing device (e.g., the cellular telephone 100) accepts user interactions (e.g., using a keypad, etc.) to identify a target web asset (e.g., website, webpage, etc.) for being presented by the computing device. For example, the web browser 102 or other type of asset presenter (e.g., a software application) may be executed by the cellular telephone 100 for the user to target one or more webpages. Upon being identified, operations of the web browser 102 may include requesting, via the Internet 202, content from one or more webpage sources 204 a,b,c for the target webpage(s). As illustrated, in this particular example, a webpage is requested from web asset source 204a and a corresponding web asset file or files 206 are sent from the source through the Internet 202 to the cellular telephone 100. In one arrangement, the web asset files 206 include a hypertext markup language (HTML) file that includes instructions for presenting the asset and a cascading style sheet (CSS) file that provides presentation semantics for the asset being provided by the HTML file.

To determine if the web browser 102 is capable of providing a kerning process for presenting font characters, one or more techniques and methodologies may be implemented. For example, operations may be executed at one or more locations for making the determination. In the illustrated example, operations may be executed by the cellular telephone 100 (or other types of user computing devices) and a font service provider 208, which is in communication with the computing device through one or more networks (e.g., the Internet 202). The font service provider 208 may incorporate one or more architectures, layouts, etc. For example, the font service provider 208 may incorporate a relatively large distributions of systems, computing devices (e.g., servers), etc. deployed in one or more locations (e.g., different geographical locations) and can be considered a content delivery network. Once determined if the web browser is capable of supporting a font character kerning process or not, the font service provider 208 may execute operations to provide appropriate information to the computing device for presenting font characters that employ kerning for either situation (e.g., the web browser supports kerning or the web browser does not support kerning for font characters). In other arrangements, the font information may be provided regardless of whether the asset presenter is capable of supporting kerning operations or not. As illustrated in the figure, a font file 210 represents the kerning information that is sent from the font service provider 208 to the user device (i.e., the cellular telephone 100). Once the kerning information is received, the information is used by the user device (e.g., executed by an asset presenter such as the web browser 102) to present the font characters of the asset with appropriate kerning of the characters. In some arrangements, the asset presenter may also allow manual adjustments to the kerning of characters. In the illustrated example, a determination is made whether a web browser supports kerning of font characters, however such a determination may be made for other types of web asset presenters. For example, along with web browsers, a web asset presenter may be considered as one or more applications (referred to as a web-based application) that can access or be accessed over a network such as the Internet, an intranet, etc. Such web-based applications may also be considered as software applications that are hosted over a network and coded in a browser supported programming language (such as JavaScript, combined with a browser-rendered markup language such as HTML, etc.). A web asset presenter may also be one or more applications (e.g., a native application) executed on a computing device (or multiple devices) such as a user device (e.g., the cellular telephone 100) that provides a view of a web asset (e.g., a web view). Similar applications executed locally, remotely, or in combination among multiple locations may be considered as a web asset presenter. Similar to making the determination for web asset presenters, such a determination may be made for asset presenters that do not communicate with networks such as the Internet. For example, an asset presenter may be considered as one or more applications locally executed by a computing device that is capable of presenting network based assets such webpages, websites, etc. without being in communication with the Internet.

One or more architectures may be implemented by the font service provider 208 for determining if an asset presenter is capable of employing character kerning along with other functionality. In some example, identifying the asset presenter may provide this determination (e.g., by identifying the type of asset presenter, the font service provider 208 can determine which font information, if any, needs to be provided to the asset presenter). In the illustrated arrangement, a font service manager 212 is executed by a server 214 located at the font service provider 208. To prepare and provide the kerning information in the font file 210 (or files) to the user device, the font service manager 212 may access information from one or more sources such as a storage device 216 (e.g., one or more hard drives, CD-ROMs, etc.) located at the font service provider 208. However, the kerning information provided by the server 214 may also be collected from one or more other sources located internal or external to the font service provider 208. For example, the kerning information may be extracted from a font provided to the font service provider 208. In one arrangement, upon receiving and executing the web asset file(s) 206 (e.g., the HTML file), the web browser 102 may initiate a request to be delivered to the font service provider 208 that asks for a software agent to be sent to the user device (e.g., the cellular telephone 100). Such agents can be considered as a software module that may be executable in a substantially autonomous manner. For example, upon being provided to the user computer device (e.g., the cellular telephone 100), a software agent may operate without considerable user interaction. By operating in a somewhat flexible manner, the software agent can adaptively provide information to the font service provider 208 that identifies if the web browser 102 being executed by the user device is capable of supporting kerning for presenting font characters. In one arrangement, the software agent may be implemented as a file that includes scripting language that is capable of supporting a variety of programming styles (e.g., JavaScript). Once received, the software agent may be executed (e.g., by the web browser 102) to determine if the executed browser 102 is capable of kerning font characters. To make such a determination, one or more techniques may be implemented. For example, by identifying the browser being executed (e.g., from information such as browser type, version, manufacturer, etc.) the software agent may use one or more predefined rules (e.g., one version of Microsoft Internet Explorer supports font character kerning, another version of Microsoft Internet Explorer does not support kerning, etc.) to determine if the web browser is capable of kerning font characters for presentation. Along with a rules-based determination being used by the software agent to determine if a web browser supports kerning for font characters, other techniques and methodology may be implemented. For example, the software agent may poll the asset presenter (e.g., web browser), test the asset presenter, etc. to determine if the asset presenter supports kerning of font characters.

Operations may be executed remotely from the user device to determine if an asset presenter (e.g., executed by the user device) is capable of supporting kerning of font characters. For example, operations may be executed at the font service provider 208 (with or without operations being executed on the user device) for making such determinations. In one arrangement, the font service provider 208 may use information provided by the user device to execute the determinations. For example, software (e.g., a user agent) operating in association with asset presenter (e.g., the web browser 102) may provide information to the font service provider 208. Along with identifying information associated with the asset presenter (e.g., web browser name, type, version, capabilities, etc.), the user agent may also provide other information such as device information (e.g., type of user device, version, capabilities, etc.), other software executed by the device (e.g., operating system, applications, etc.) and other types of information (e.g., protocols being used by the web browser, etc.). From the provided information, the font service provider 208 may determine if the user device (e.g., cellular telephone 100) is capable of supporting kerning of font characters. Additionally, the provided information may be used by the font service provider 208 for identifying information needed by the browser to support kerning of font character fonts.

In some arrangements, testing operations may be executed by the asset presenter and the font service provider to make such determinations of the asset presenter's ability to appropriately apply kerning to text of an asset. For example, the asset presenter may be requested to produce asset, a portion of an asset, test characters, etc. (e.g., a line of text, a paragraph, a string of characters, etc.) that can be compared to a similar asset, asset portion, test characters, etc. produced by the font service provider. In some arrangements, the information from an asset such as (e.g., information from a document object model (DOM) may be used for the comparison. If the comparison reports similar results (e.g., within one or more predefined rules, thresholds, etc.), the asset presenter may be considered as being capable of providing appropriate kerning support. If the comparison reports differences between the two (e.g., the one or more predefined rules, thresholds, etc. are not met), the asset presented may be considered by the font service provider as not being capable of supporting kerning operations. Armed with the results of this comparison, the font service provider may initiate corrective action such as having appropriate kerning information being sent to the asset presenter. Producing such assets, asset portions, test characters, etc. may implement one or more techniques and methodologies. For example, production may be executed by the asset presenter offline (e.g., the produced asset, asset portion, test characters are not displayed on the device but just provided to the font service provider for comparison etc.). Not viewable, the device user may be unaware of the content representation (e.g., referred to as an “off screen bitmap”, etc.) being prepared by the asset presenter for the comparison. The number of comparisons and the scale of the comparisons may also vary in different arrangements. For example, the asset presenter may be requested to produce a relatively detailed asset (e.g., a webpage the presents a large variety of characters, fonts, etc.) for the determination. From such detail, a single comparison to a similarly detailed asset (produced by the font service provider) may be sufficient to indicate if the asset presenter can support kerning operations or not. In another arrangement, the asset presenter may be asked to produce an asset that includes relatively little content (e.g., a single line of text, a few characters, etc.). Compared to similar content produced by the font service provider, the comparison can serve as an independent data point. Once a statistically significant number of comparisons have been executed and collected (e.g., one thousand samples), a decision may be rendered by the font service provider as to whether this particular type of asset presenter is capable of supporting kerning operations or not. Variants of these techniques may also be employed, for example, a combination of comparisons of detailed content and relatively spare content may be used in the determination. Frequency of the appearance of different types of asset presenters may also dictate the comparisons executed. For example, for less frequently appearing asset presenters, a single comparison of a large detailed asset may be executed, while for more frequently appearing types of asset presenters (e.g., the same browser is installed on a large percentage of newly introduced devices) a series of smaller less detailed assets (e.g., a string of characters) may be used for the comparison. Temporal aspects may also factor into the type of comparison executed. For example, for particular times of the day, days of the weeks, seasons of the year, etc., one type of comparison may be preferable over another type of comparison. Various sources may be used for providing the content of executing the production by the asset presenter and the font service provider. For example, test assets may be stored at the font service provider and provided to the asset presenter (along with the request to provide an “off screen bitmap”). In some arrangements, assets or portions of assets accessed by the asset presenter (from one or more sources) may be used for the comparison. Once the determinations are made, the font service provider may store data that represents the determination (e.g., in the storage device 216) along with other information such as identifying information of the asset presenter. As such, a collection of information (e.g., a database) may be produced, stored, updated, etc. at the font service provider 208 that tracks the identity of different asset presenters and their capabilities (e.g., in regards to providing kerning operations).

Software agents provided to the user device may also provide other type of functionality. For example, a software agent may also gather other information for having a target web asset (that includes text) to be presented by the user computing device. For example, the software agent may identify the particular text-related information from the web asset that may be needed from the font service provider 208 to present the asset. In one arrangement, the software agent may scan the CSS file provided with the web asset file(s) 206 of the web asset to determine such text-related information included in the web asset. The software agent may also review the HTML file provided with the web asset file(s) 206 to identify text-related information such as the particular fonts, characters, glyphs, etc. and other types of typographical elements (e.g., ligatures, a single glyph fractions, subscripts, superscripts, etc.) being used by the asset. Other types of information may also be collected for being provided to the font service provider 208. For example, information associated with the user device, operating system used by the device, application(s) executed by the device (e.g., the type of web browser being executed by the device), etc. Once identified, this information may be provided to the font service provider 208 for processing and preparing the needed information for delivery to the user computing device (e.g., the cellular telephone 100) for kerning and presenting the content of the asset. Along with text-related information, other types of information may be provided to the font service provider 208. For example, the particular fonts, characters, typographical features, etc. included in the content of the web asset may be identified (e.g., by a software agent) and provided. In response to being provided this information, the font service manager 212 may prepare one or more subsets of appropriate font data (along with the kerning information) such that the only font information provided to the user device is the information needed to present the web asset and no additional font information (e.g., font characters not included in the web asset) is transmitted from the font service provider 208 to the user computing device.

Referring to FIG. 3, a diagram 300 graphically illustrates data transfers such that appropriate information (e.g., kerning information) is provided to asset presenters (e.g., web browsers) for presenting web assets based upon whether or not the asset presenter supports kerning of font characters. In this illustration, one computing device (i.e., the cellular telephone 100) does not support this capability and another computing device (i.e., a tablet computing device 302) is capable of performing kerning operations for font characters. Both devices respectively execute browsers 102, 304, which in this example, are directed to the same target web asset. From the source of the web asset, the corresponding web asset file(s) 206 are provided to each device 100, 302. Upon receiving the file(s), software agents 306, 308 are respectively provided to the devices (e.g., from the font service provider 208) or are previously residing and are executed (e.g., to collect information, determine the corresponding device is capable of kerning font characters, etc.). To initiate the delivery of the software agents 306, 308, one or more techniques may be implemented. For example, once delivered, the web asset file(s) 206 (e.g., an HTML file and a CSS file) may be used (e.g., executed) by the recipient device to initiate a request being sent to the font service provider 208. Receiving the request, a software agent (e.g., a JavaScript file) may be sent as a reply from the font service manager 212 being executed by the server 214 at the font service provider 208. Along with sending the software agent, the font service provider 208 may perform other operations associated with the software agent. For example, at predefined times (e.g., intervals, event triggered times, etc.) the agent may be updated by the font service provider 208 as information is collected. Information regarding which types of browsers is capable of supporting kerning operations, incapable of supporting kerning operations, etc. may be gathered and included in updated versions of the software agent. The font service manager 212 may execute other operations in some arrangements. For example, the font service manager 212 may determine if a web browser is capable of supporting or not supporting kerning of font characters. In some arrangements, based upon the information received from a user device (e.g., the type of browser being executed by the device in a request such as request 310), the font service manager 212 may be able to determine if font character kerning is supported by the device and execute appropriate operations. For example, information associated with the asset presenter (e.g., web browser 304) and collected by a user agent may be provided in the request (being sent from the device to the font service provider 208). Such information may also be provided in a request initiated by the asset presenter (e.g., by executing one or more instructions included in one or more of the web asset file(s) 206). From the provided information and possibly other information (e.g., present at the font service provider 208), the font service manager 212 may determine the kerning capabilities of the asset presenter executed by the device and take appropriate action.

The software agents 306, 308 may be capable of performing other operations. For example, operations may be respectively executed by the software agents 306, 308 to collect information regarding font information, character information and other content of the web asset being provided by the web asset file(s) 206. In one example, each software agent may read the CSS file included with the web asset file(s) 206 to identify which font information (e.g., type of font(s), etc.) may be used by the asset. The software agent may also read the HTML file included with the web asset file(s) 206 to identify the particular characters, typographical features, etc. that may be used by the web asset. In some arrangements, the software agent may read information of the HTML file from other sources, for example, information from a document object model (DOM), a node-based structure used to organize the information (e.g., a DOM tree), etc. By identifying data such as the fonts, characters, etc. used by the web asset, one or more advantageous operations may be executed. For example, if a relatively small number of adjacent character combinations for a particular font are identified as being presented for the web asset, an appropriate subset of kerning information for addressing those identified character combinations may be provided by the font service provider 208, thereby conserving processing time and memory by not having kerning information associated character combinations absent from the web asset being sent to the corresponding user device. Incremental subsetting techniques may also be employed. For example, after a subset of kerning information is produced for the combination of adjacent font characters present in a first page of a web asset, this identified kerning information may not be used for producing subset(s) for subsequent pages (e.g., a second page) of the web asset. By filtering kerning information already present in a previously produced subset, less processing time and memory may be consumed in a redundant manner.

To provide the collected information (e.g., information collected by a user agent such as browser type, font(s) used by the asset, character combinations present in the asset, etc.) one or more techniques or methodologies may be implemented. For example, to provide the collected information to the font service provider 208, each of the user devices 100, 302 may send a corresponding request 310, 312 to the font service provider. In this arrangement, each device is wirelessly connected to the one or more networks (e.g., the Internet) for exchanging information with the font service provider 208, as represented with the respective graphics 314, 316. Upon receiving the requests 310, 312, the font service manager 212 prepares kerning information for the devices based upon the information provided in each respective request. For example, dependent upon the capability of the corresponding browser, different types of information may be respectively prepared and sent by the font service provider 208. In the illustrated arrangement, a font file 318 is prepared and sent to the device 302 executing the web browser 304 that is capable of supporting kerning for font characters. In general, the information included in the font file 318 allows the device 302 to appropriately apply kerning to adjacent characters of the web asset as authored. In one arrangement, the provided font file 318 may include information for one or more fonts to be presented in the target asset. Kerning information may be included, for example, in one or more tables associated with each of the fonts to be presented. Such tables may include a glyph positioning (GPOS) table, a kerning table (e.g., a Kern table), etc. that respectively provide glyph placement information.

Some web browsers or other types of asset presenters are unable to support kerning of font characters. In such situations, one or more techniques may be implemented to enable kerning operations. For example, one or more executable files may be provided to the asset presenter (e.g., a non-supporting web browser) such that when executed, the adjacently located font characters are appropriately spaced. For example, one or more JavaScript files may be provided that when executed initiate kerning operations at run-time such that kerning is appropriately applied to each corresponding pair of adjacent font characters. In general, kerning information is associated with one particular font; thereby a separate set of kerning information is needed for each font included in an asset. The kerning information used in the one or more executable files may be provided from one or more sources. For example, as fonts are provided (e.g., newly developed fonts, updated fonts, etc.) to font service provider 208 for use in asset presentation, kerning information may be extracted (e.g., from a GPOS table, a Kern table, etc. associated with a font). Once attained, the kerning information (e.g., spacing for particular pairs of characters) may be utilized by instructions included in the one or more executable files (e.g., JavaScript files) to support kerning.

In this example, recognizing that the web browser 102 of the device 100 does not support kerning (e.g., from the information provided by the request 312), the kerning information may be provided differently to the user device (compared to the font file 318 sent to the user device 302 capable of supporting kerning of font characters). One or more techniques may be implemented to provide kerning information to non-supporting web browsers for presenting, for example, assets that employ one or more fonts. In the illustrated example, based upon the information included in the request 312, multiple files may be sent from the font service provider 208 to the non-supporting browser 102 of user device 100. In particular, a font file 320 is delivered from the font service provider 208 that includes some font information needed to present the font content of the web asset. In some examples, font information may only be provided for the content included in the web asset to be presented. As such, a subset of information (needed to present the asset) may be provided (e.g., font information for characters present in the web asset), thereby conserving sources such as memory, processing time, throughput (and/or other transmission characteristics), etc.

In addition to the font file 320, an executable file 322 (or multiple executable files) may be provided by the font service provider 208. Typically, the executable file 322 (e.g., a JavaScript file) includes operations for applying kerning to font characters. For example, the executable file 322 may include operations for kerning adjacent characters of each type of font included in the target web asset. Kerning information utilized by the operations may be attained from font information (e.g., extracted from a GPOS table, a Kern table, etc.) residing at or provided to the font service provider 208. Similar to the font files 318, 320, the contents of the executable file 322 may be reduced based upon the subset of material included in the web asset. For example, operations (e.g., instructions) may be absent from the executable file 322 if corresponding fonts, font characters, etc. are not included in the content of the web asset. Further, multiple executable files may be sent from the font service provider 208 to the device rather than a single executable file. For example, multiple files may be used for delivering the operations for providing kerning information. Along with using the information provided from the font service provider 208 for font character kerning (e.g., by asset presenters that support or do not support kerning operations), the information (e.g., provided by one or more font files, executable files, etc.) may be used by other applications. For example, this information may be utilized by an editor, executed locally (e.g., by a user device) or remotely (e.g., at the font service provider or other location), for a variety of tasks (e.g., creating content, editing content, managing content, etc.). For example, an editor that allows a user to select various types of characters (e.g., to create different types of presentations, assets, applications, etc.) may utilize the kerning information. Along with different types of editors, various types of user interfaces may be implemented. For example, interfaces may be implemented that are directed toward use on a local computer. Similarly, interfaces may be implemented for remotely located computer systems (e.g., cloud-based computer systems and services) and other types of computer and network architectures.

Referring to FIG. 4, a variety of methodologies and techniques may be implemented by the one or more executable files (e.g., executable file 322) to assist an asset presenter that lacks the ability to support font character kerning. For example, operations provided by executable file(s) may use logic for determining the appropriate spacing of adjacent font characters located in an asset. In one implementation, the executable file(s) may utilize a collection of rules (e.g., represented in JavaScript instructions) to determine the spacing between detected character pairs. Such rules may be applied as content of the web asset is scanned (e.g., by scanning an HTML file, by scanning a DOM, a DOM tree, etc.). In one arrangement, the scanned characters may be used to determine if one or more predefined executable operations (e.g., methods, functions, etc.) are present for applying appropriate kerning. For some architectures, determining if a particular executable operation exists may be more computationally efficient than comparing scanned characters to each rule in a collection for handling every permutation of character pairs. For example, as characters are sequentially scanned (e.g., the character “A” is scanned followed by the character “V”), a relatively quick determination may be made if an operation (e.g., method, function, etc.) exists that uses the scanned character in the name of the operation (e.g., a method entitled “A followed by V kerning method”). If such an operation does exist that uses the scanned characters, then the operation (or operations) may then be executed. If determined that such an operation for the scanned characters does not exist, no spacing adjustment is made between the two identified characters (e.g., a zero spacing is applied between the characters) and the process continues for checking the next sequential pair of character of the asset to determine if a corresponding operation (e.g., method, function, etc.) exists for those characters. In some arrangements, data representing these (and other previously executed) determinations may be stored (e.g., cached) such that the same determinations do not need to be re-executed, and thereby further improve processing efficiency.

Other types of techniques may also employed for identifying the particular kerning information to be applied based upon two font characters being adjacently located in the content of an asset. For example in one technique, font characters having similar shapes may be grouped into classes. Rules may be developed for adjusting the spacing between the different classes, rather than just having rules for addressing every possible character pairing. As illustrated in the figure, two classes of characters 400, 402 are shown for demonstrative purposes. Each of the classes 400, 402 are defined based upon a common shape that is substantially shared by each character member of the respective class (however, multiple shapes may be used in some arrangements). For example, class 400 is illustrated as having both the lower case character “b” and the lower case character “p”. Both of these two characters share a similar rounded shape 404 that is located at the lower right portion of the character. In a similar manner, each of the two characters of the class 402 (e.g., the lower case character “o” and the lower case character “e”) share a similar rounded shape 406 that is located in the lower left portion of each character. Being aware of the geometry of the shapes associated with each class, rules may be developed for applying the appropriate kerning spacing when characters from these two classes are detected as being adjacent. For example, one character from class 400 (e.g., the lower case character “p”) may be positioned to the left of one character from the class 402 (e.g., the lower case character “o”) such as in the word “popular” (emphasis added). Due to their positioning, the characters may be appropriately spaced based upon the knowledge that a character with the shape 404 (e.g., a member of class 400) is located to the left of a character with shape 406 (e.g., a member of class 402). By employing rules developed from character classes rather than developed from individual character pairings, resources (e.g., memory) may be conserved and operations may be executed more efficiently, for example, less computational time may be needed to detect and process adjacently located character classes than needed to identify and execute a rule defined for a particular pair of adjacent characters.

Defining such classes may be implemented using a variety of similarity among the class members. For example, multiple shapes (e.g., two or more shapes) included in each character may be used for identifying class members. Other types of geometrical information may also factor into class membership, for example, lower case characters may be assigned to one class while upper case characters may be assigned to another class. The geometrical information may be implemented in various representations that may be exploited for identifying character pairings. For example, representations such as vector graphics (e.g., scalable vector graphics (SVG), inline SVG, SVG Tiny, etc.) or other techniques that use geometrical primitives for representing characters may be implemented. In some instances, some characters may be members of multiple classes while in some arrangements, characters may be restricted to membership in one or a predefined number of classes. One or more application techniques may be implemented to utilize one or more defined classes. For example, classes may be used in concert with rules for individual character pairings. In one arrangement, content of an asset may be initially scanned to identify if appropriate kerning information can be determined from individual pairings of adjacent characters (e.g., determine if a process exists for the character “A” followed by the character “V”). Upon scanning the content to identify kerning information from the individual character pairings, the content of the asset may be scanned to identify adjacently positioned members of the same class or different classes. Once the pairing of adjacent characters have been identified by from the individual characters, assigned classes, etc., the character pair may be appropriately spaced based upon the corresponding kerning information.

Referring to FIG. 5a a flowchart 500 represents operations of a font service manager (e.g., the font service manager 212 shown in FIG. 2). Operations of the font service manager are typically executed by a single computing device (e.g., the server 214 also shown in FIG. 2); however, operations of the font service manager may be executed by multiple computing devices. Along with being executed at a single site (e.g., the font service provider 208 shown in FIG. 2), operation execution may be distributed among two or more locations.

Operations of the font service manager may include receiving 502 information that identifies an asset presenter (e.g., a web browser) being executed by a computing device. For example, a request may be sent from the computing device to the font service provider (where the font service manager is executed) that contains information that identifies the type of web browser being executed by the computing device. Operations may also include, based on the identity of the asset presenter, determining 504 whether the asset presenter is capable of adjusting the spacing between adjacent font characters present in content of an asset provided across one or more networks. For example, the font service manager may access a one or more databases, initiate a comparison test, etc. to attain information that indicates whether or not the web browser executed by the computing device supports kerning of font characters. Operations may also include, in response to receiving the information, sending 506 font information to the computing device to allow the spacing of the adjacent font characters present in the content of the asset to be adjusted for presentation by the computing device. For example, a font file may be sent by the font service provider that includes kerning information (e.g., a kerning table), an executable file (e.g., a JavaScript file) and/or other information for adjusting the spacing (e.g., kerning) of characters included in the content of the asset (e.g., webpage, website, etc.) prior to presentation.

Referring to FIG. 5b, a flowchart 510 represents operations of a font service manager (e.g., the font service manager 212 shown in FIG. 2). Operations of the font service manager are typically executed by a single computing device (e.g., the server 214 also shown in FIG. 2); however, operations of the font service manager may be executed by multiple computing devices. Along with being executed at a single site (e.g., the font service provider 208 shown in FIG. 2), operation execution may be distributed among two or more locations.

Operations of the font service manager may include receiving 512 information that represents font characters and spacing of adjacent font characters. For example, a font may be designed (e.g., by a professional developer) and provided (e.g., uploaded) to a font service provider (e.g., the font service provider 208 shown in FIG. 2). Multiple files may be provided that include information for presenting individual characters in the designed font (e.g., glyphs, outlines, etc.). The multiple files may also include kerning information for spacing adjacent characters to be presented in the font. Operations may also include extracting 514 information that represents the spacing of the adjacent font characters from the received information. For example, kerning information associated with the designed font may be extracted from the received files. In one arrangement, this kerning information may be extracted from a kerning table, a glyph positioning table, etc. for individual font characters. Operations may also include using 516 the extracted information to produce an executable file that contains instructions for adjusting the spacing between adjacent font characters present in content of an asset. For example, one or more JavaScript files may be produced that include instructions for appropriately kerning font characters present in an asset such as a web asset (e.g., webpage, website, etc.). Operations may also include sending 516 the executable file to a computing device for spacing the adjacent font characters of the asset content for presentation by the computing device. For example, the JavaScript files may be sent (e.g., over the Internet) to a computer system for kerning the textual content of a website or webpage to be displayed by the device (e.g., a display of a tablet computing device). Through these operations kerning information is provided to computing devices lacking this information and thereby allowing assets such as web assets to be presented to end users as originally designed.

In some arrangements, other techniques may be employed to provide kerning information to one or more devices. For example, a developer, designer, etc. associated with fonts may produce kerning information for one or more fonts. For example, using a computer system, a developer may introduce, manipulate, etc. the kerning of font characters (e.g., adjust the spacing between characters, character groups, etc.). Such adjustments may be performed on a stand-alone computer system, a networked computer system (e.g., a computer system in communication with a font provider), etc. Once the kerning adjustments are determined, this information may be provided to the font service provider for delivery to computing devices. In such implementations, the kerning information may be directly provided to the font service provider with or without font information (e.g., data defining font characters). As such, the kerning information may not need to be extracted from font information. Once provided to the font service provider, the kerning information may be sent to computing devices in need (e.g., to present content in one or more fonts associated with the kerning information). The kerning information may also be stored, further processed, etc. by the font service provider. While the font service provider can distribute the kerning information, in some arrangements the information may be disseminated by other entities. For example, other computing devices (e.g., the computing device used for kerning adjustments) may initiate the delivery of kerning information, for example, as directed by the font service provider.

FIG. 6 is a block diagram showing an example of a system 600 for providing hosted storage and accessing the hosted storage from a client device 602. In some implementations, a hosted storage service 620 may provide access to stored data (e.g., kerning information) by applications (e.g., web browsers) running on computing devices operating separately from one another, provide offsite data backup and restore functionality, provide data storage to a computing device with limited storage capabilities, and/or provide storage functionality not implemented on a computing device.

The system 600 may provide scalable stores for storing data resources. The client device 602 may upload data resources to the hosted storage service 620 and control access to the uploaded data resources. Access control may include a range of sharing levels (e.g., private, shared with one or more individuals, shared with one or more groups, public, etc.). Data stored in hosted storage service 620 can be secured from unauthorized access. The hosted storage service 620 can use a simple and consistent application programming interface, or API, which can allow arbitrary quantities of structured or unstructured data to be kept private or shared between individuals, organizations, or with the world at large. The client device 602 may access, retrieve, be provided, store, etc. data in the hosted storage service 620 for any number of a variety of reasons. For example, data may be stored for business reasons (e.g., provide identification information to attain access clearance for kerning data at the hosted storage service 820), or for use in data processing by other services.

The client device 602 may be implemented using a computing device, such as the computing device 700 or the mobile device 750 described with respect to FIG. 7. The client device 602 may communicate with the hosted storage service 620 via a network 604, such as the Internet. The client device 602 may communicate across the network using communication protocols such as, for example, one or more of Transmission Control Protocol/Internet Protocol (TCP/IP), Hypertext Transfer Protocol (HTTP), Secure Shell Remote Protocol (SSH), or Application Program Interfaces (API). While only a single client device 602 is shown, there may be multiple client devices communicating across the network 804 with the hosted storage service 620 and/or other services and devices.

The hosted storage service 620 may be implemented such that client applications executing on client device 602, such as a client application 603, may store, retrieve, or otherwise manipulate data resources in the hosted storage service 620. The hosted storage service 620 may be implemented by one or more server devices, which may be implemented using a computing device, such as the computing device 700 or mobile device 750 described with respect to FIG. 7. For example, the hosted storage service 620 may be implemented by multiple server devices operating in the same, or different, data centers.

The hosted storage service 620 generally includes an interface frontend 606, an interface backend 608, a storage backend 610, and metadata 616 for resources stored in the storage backend 610. The hosted storage service 620 may also include an authenticator 609 to verify that a user requesting one or more fonts should be provided access to the fonts (e.g., based on a service subscription, rental period, etc.).

In general, the interface frontend 606 may receive requests from and send responses to the client device 602. For instance, the hosted storage service 620 may be implemented as a Web Service with a corresponding set of Web Service Application Programming Interfaces (APIs). The Web Service APIs may be implemented, for example, as a Representational State Transfer (REST)-based HTTP interface or a Simple Object Access Protocol (SOAP)-based interface. Interface frontend 606 may receive messages from the client 602 and parse the requests into a format usable by the hosted storage service 620, such as a remote procedure call (RPC) to an interface backend 608. The interface frontend 606 may write responses generated by the hosted storage service 620 for transmission to the client 602. In some implementations, multiple interface frontends 606 may be implemented, for example to support multiple access protocols.

The interface frontend 606 may include a graphical front end, for example to display on a web browser for data access. The interface frontend 606 may include a sub-system to enable managed uploads and downloads of large files (e.g., for functionality such as pause, resume, and recover from time-out). The interface frontend 606 may monitor load information and update logs, for example to track and protect against denial of service (DOS) attacks.

As described above, the Web Service API may be a REST-based HTTP interface. In a REST-based interface, a data resource is accessed as a resource, uniquely named using a uniform resource identifier (URI), and the client application 603 and service 620 exchange representations of resource state using a defined set of operations. For example, requested actions may be represented as verbs, such as by HTTP GET, PUT, POST, HEAD, and DELETE verbs. The GET verb may be used to retrieve a resource, while the HEAD verb may be used to retrieve information about a resource without retrieving the resource itself. The DELETE verb may be used to delete a resource from the hosted storage service 620. The PUT and POST verbs may be used to upload a resource to the service 620. PUT requests may come from the client 602 and contain authentication and authorization credentials and resource metadata in a header, such as an HTTP header. POST requests may be received when a client 602 wants to upload from a web browser form. The form POST upload protocol for the hosted storage service 620 may involve multiple form fields to provide authentication, authorization, and resource metadata. More generally, any of the API requests may include credentials for authentication and authorization, for example in a header of the request. An authorization header may be included in the REST requests, which may include an access key to identify the entity sending the request.

Alternatively, or additionally, a user may be authenticated based on credentials stored in a browser cookie, which may be appended to the API requests. If no valid cookie is present, a redirect to an authentication frontend may be generated, and the authentication frontend may be used to generate the browser cookie. The authentication frontend may be used by systems and services in addition to the hosted storage service 620 (e.g., if the organization operating the hosted storage service 620 also operates other web services such as email service). A user may also or alternatively be authenticated based on authentication credentials from an external credentialing service or an external service that includes credentialing functionality. User or group identifier information may be calculated from the external service's credential information. Requests sent by the client 602 to the interface frontend 606 may be translated and forwarded to the external service for authentication.

In general, resources stored in the hosted storage service 620 may be referenced by resource identifiers. The hosted storage service 620 may define namespaces to which a valid resource identifier must conform.

Resources (e.g., objects such as font data) may be stored in hosted storage service 620 in buckets. In some examples, each bucket is uniquely named in the hosted storage service 620, each data resource is uniquely named in a bucket, and every bucket and data resource combination is unique. Data resources may be uniquely identified by a URI that includes the bucket name and the resource name, and identifies the hosted storage service 620.

The interface backend 608 along with the authenticator 609 may handle request authentication and authorization, may manage data and metadata, and may track activity such as for billing. As one example, the interface backend 608 may query the authenticator 609 when a request for one or more fonts is received. The interface backend 608 may also provide additional or alternative functionality. For example, the interface backend 608 may provide functionality for independent frontend/backend scaling for resource utilization and responsiveness under localized heavy loads. Data management may be encapsulated in the interface backend 608 while communication serving may be encapsulated in the interface frontend 606. The interface backend 608 may isolate certain security mechanisms from the client-facing interface frontend 606.

The interface backend 608 may expose an interface usable by both the interface frontend 606 and other systems. In some examples, some features of the interface backend 608 are accessible only by an interface frontend (not shown) used by the owners of the hosted storage service 620 (internal users). Such features may include those needed for administrative tasks (e.g., resolving a resource reference to a low level disk address). The interface backend 608 may handle request authentication (e.g., ensuring a user's credentials are valid) and authorization (e.g., verifying that a requested operation is permitted). The interface backend may also provide encryption and decryption services to prevent unauthorized access to data, even by internal users.

The interface backend 608 may manage metadata 616 associated with data resources. User-specified names can be completely defined within the metadata 616, and resource metadata 616 can map a resource name to one or more datastores 612 storing the resource. The metadata 616 can also contain resource creation times, resource sizes, hashes, and access control lists 618 (ACL 618) for resources. The interface backend 608 can log activity and track storage consumption to support accounting for billing and chargebacks. In some examples, this includes quota monitoring in each dimension in which customers are charged (e.g., reads, writes, network transfers, total storage in use).

The ACLs 618 may generally define who is authorized to perform actions on corresponding buckets or resources, and the nature of the permitted actions. The ACLs 618 may be an unordered list of {scope, role} pairs, plus Boolean flags.

The storage backend 610 may contain multiple datastores 612a-612c. Although three datastores 612 are shown, more or fewer are possible. Each of the datastores 612a-612c may store data resources 614a-614c in a particular format. For example, data store 612a may store a data resource 614a as a binary object, data store 612b may store a data resource 614b in a distributed file system, and data store 612c may store a data resource 614c in a database.

FIG. 7 shows an example of example computer device 700 and example mobile computer device 750, which can be used to implement the techniques described herein. For example, a portion or all of the operations of the font service manager 212 (shown in FIG. 2) may be executed by the computer device 700 and/or the mobile computer device 750. Computing device 700 is intended to represent various forms of digital computers, including, e.g., laptops, desktops, workstations, personal digital assistants, servers, blade servers, mainframes, and other appropriate computers. Computing device 750 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 700 includes processor 702, memory 704, storage device 706, high-speed interface 708 connecting to memory 704 and high-speed expansion ports 710, and low speed interface 712 connecting to low speed bus 714 and storage device 706. Each of components 702, 704, 706, 708, 710, and 712, are interconnected using various busses, and can be mounted on a common motherboard or in other manners as appropriate. Processor 702 can process instructions for execution within computing device 700, including instructions stored in memory 704 or on storage device 706 to display graphical data for a GUI on an external input/output device, including, e.g., display 716 coupled to high speed interface 708. In other implementations, multiple processors and/or multiple buses can be used, as appropriate, along with multiple memories and types of memory. Also, multiple computing devices 700 can be connected, with each device providing portions of the necessary operations (e.g., as a server bank, a group of blade servers, or a multi-processor system).

Memory 704 stores data within computing device 700. In one implementation, memory 704 is a volatile memory unit or units. In another implementation, memory 704 is a non-volatile memory unit or units. Memory 704 also can be another form of computer-readable medium, including, e.g., a magnetic or optical disk.

Storage device 706 is capable of providing mass storage for computing device 700. In one implementation, storage device 706 can be or contain a computer-readable medium, including, e.g., a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, including, e.g., those described above. The data carrier is a computer- or machine-readable medium, including, e.g., memory 704, storage device 706, memory on processor 702, and the like.

High-speed controller 708 manages bandwidth-intensive operations for computing device 700, while low speed controller 712 manages lower bandwidth-intensive operations. Such allocation of functions is an example only. In one implementation, high-speed controller 708 is coupled to memory 704, display 716 (e.g., through a graphics processor or accelerator), and to high-speed expansion ports 710, which can accept various expansion cards (not shown). In the implementation, low-speed controller 712 is coupled to storage device 706 and low-speed expansion port 714. The low-speed expansion port, which can include various communication ports (e.g., USB, Bluetooth®, Ethernet, wireless Ethernet), can be coupled to one or more input/output devices, including, e.g., a keyboard, a pointing device, a scanner, or a networking device including, e.g., a switch or router, e.g., through a network adapter.

Computing device 700 can be implemented in a number of different forms, as shown in the figure. For example, it can be implemented as standard server 720, or multiple times in a group of such servers. It also can be implemented as part of rack server system 724. In addition or as an alternative, it can be implemented in a personal computer including, e.g., laptop computer 722. In some examples, components from computing device 700 can be combined with other components in a mobile device (not shown), including, e.g., device 750. Each of such devices can contain one or more of computing device 700, 750, and an entire system can be made up of multiple computing devices 700, 750 communicating with each other.

Computing device 750 includes processor 752, memory 764, an input/output device including, e.g., display 754, communication interface 766, and transceiver 768, among other components. Device 750 also can be provided with a storage device, including, e.g., a microdrive or other device, to provide additional storage. Each of components 750, 752, 764, 754, 766, and 768, are interconnected using various buses, and several of the components can be mounted on a common motherboard or in other manners as appropriate.

Processor 752 can execute instructions within computing device 750, including instructions stored in memory 764. The processor can be implemented as a chipset of chips that include separate and multiple analog and digital processors. The processor can provide, for example, for coordination of the other components of device 750, including, e.g., control of user interfaces, applications run by device 750, and wireless communication by device 750.

Processor 752 can communicate with a user through control interface 758 and display interface 756 coupled to display 754. Display 754 can be, for example, a TFT LCD (Thin-Film-Transistor Liquid Crystal Display) or an OLED (Organic Light Emitting Diode) display, or other appropriate display technology. Display interface 756 can comprise appropriate circuitry for driving display 754 to present graphical and other data to a user. Control interface 758 can receive commands from a user and convert them for submission to processor 752. In addition, external interface 762 can communicate with processor 742, so as to enable near area communication of device 750 with other devices. External interface 762 can provide, for example, for wired communication in some implementations, or for wireless communication in other implementations, and multiple interfaces also can be used.

Memory 764 stores data within computing device 750. Memory 764 can be implemented as one or more of a computer-readable medium or media, a volatile memory unit or units, or a non-volatile memory unit or units. Expansion memory 774 also can be provided and connected to device 750 through expansion interface 772, which can include, for example, a SIMM (Single In Line Memory Module) card interface. Such expansion memory 774 can provide extra storage space for device 750, or also can store applications or other data for device 750. Specifically, expansion memory 774 can include instructions to carry out or supplement the processes described above, and can include secure data also. Thus, for example, expansion memory 774 can be provided as a security module for device 750, and can be programmed with instructions that permit secure use of device 750. In addition, secure applications can be provided through the SIMM cards, along with additional data, including, e.g., placing identifying data on the SIMM card in a non-hackable manner.

The memory can include, for example, flash memory and/or NVRAM memory, as discussed below. In one implementation, a computer program product is tangibly embodied in a data carrier. The computer program product contains instructions that, when executed, perform one or more methods, including, e.g., those described above. The data carrier is a computer- or machine-readable medium, including, e.g., memory 764, expansion memory 774, and/or memory on processor 752, which can be received, for example, over transceiver 768 or external interface 762.

Device 750 can communicate wirelessly through communication interface 766, which can include digital signal processing circuitry where necessary. Communication interface 766 can provide for communications under various modes or protocols, including, e.g., GSM voice calls, SMS, EMS, or MMS messaging, CDMA, TDMA, PDC, WCDMA, CDMA2000, or GPRS, among others. Such communication can occur, for example, through radio-frequency transceiver 768. In addition, short-range communication can occur, including, e.g., using a Bluetooth®, WiFi, or other such transceiver (not shown). In addition, GPS (Global Positioning System) receiver module 770 can provide additional navigation- and location-related wireless data to device 750, which can be used as appropriate by applications running on device 750. Sensors and modules such as cameras, microphones, compasses, accelerators (for orientation sensing), etc. maybe included in the device.

Device 750 also can communicate audibly using audio codec 760, which can receive spoken data from a user and convert it to usable digital data. Audio codec 760 can likewise generate audible sound for a user, including, e.g., through a speaker, e.g., in a handset of device 750. Such sound can include sound from voice telephone calls, can include recorded sound (e.g., voice messages, music files, and the like) and also can include sound generated by applications operating on device 750.

Computing device 750 can be implemented in a number of different forms, as shown in the figure. For example, it can be implemented as cellular telephone 780. It also can be implemented as part of smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A computer-implemented method comprising:
receiving information that identifies an asset presenter being executed by a computing device;
based on the identity of the asset presenter, determining whether the asset presenter is capable of adjusting the spacing between adjacent font characters present in content of an asset provided across one or more networks; and
in response to the determination, sending font information to the computing device to allow the spacing of the adjacent font characters present in the content of the asset to be adjusted for presentation by the computing device.

2. The computer-implemented method of claim 1, wherein the determination is based upon information about the asset presenter accessed from a database.

3. The computer-implemented method of claim 1, wherein the determination is based upon a comparison using a content presentation produced by the asset presenter.

4. The computer-implemented method of claim 1, wherein the determination is based upon a comparison of a content presentation produced by the asset presenter and a content presentation produced by a font service provider.

5. The computer-implemented method of claim 1, wherein sending font information includes sending a font file to the computing device.

6. The computer-implemented method of claim 1, wherein sending font information includes modifying a font file prior to sending the modified font file to the computing device.

7. The computer-implemented method of claim 6, wherein modifying the font file includes removing a portion of the font file.

8. The computer-implemented method of claim 6, wherein modifying the font file includes removing a portion of a table from the font file.

9. The computer-implemented method of claim 6, wherein in modifying the font file includes removing a portion of one of a kerning table and a glyph positioning table.

10. The computer-implemented method of claim 1, wherein sending the font information includes sending a file executable by the asset presenter that contains instructions for adjusting the spacing between the adjacent font characters present in content of the asset.

11. The computer-implemented method of claim 10, wherein the executable filed is produced by a font service provider.

12. The computer-implemented method of claim 1, wherein the font information sent to the computing device to allow the spacing of the font characters present in the content of the asset to be adjusted is extracted by a font service provider.

13. The computer-implemented method of claim 1, wherein the sent font information includes one or more operations with information that identify font characters present in the content of the asset.

14. The computer-implemented method of claim 1, wherein the sent font information includes one or more operations associated with groups of font characters having similar geometry.

15. The computer-implemented method of claim 1, wherein the asset presenter includes one of a web browser, a web-based application and a web view application.

16. A system comprising:
a computing device comprising:
a memory configured to store instructions; and
a processor to execute the instructions to perform operations comprising:
receiving information that identifies an asset presenter being executed by a computing device;
based on the identity of the asset presenter, determining whether the asset presenter is capable of adjusting the spacing between adjacent font characters present in content of an asset provided across one or more networks; and
in response to the determination, sending font information to the computing device to allow the spacing of the adjacent font characters present in the content of the asset to be adjusted for presentation by the computing device.

17. The system of claim 16, wherein the determination is based upon information about the asset presenter accessed from a database.

18. The system of claim 16, wherein the determination is based upon a comparison using a content presentation produced by the asset presenter.

19. The system of claim 16, wherein the determination is based upon a comparison of a content presentation produced by the asset presenter and a content presentation produced by a font service provider.

20. The system of claim 16, wherein sending font information includes sending a font file to the computing device.

21. The system of claim 16, wherein sending font information includes modifying a font file prior to sending the modified font file to the computing device.

22. The system of claim 21, wherein modifying the font file includes removing a portion of the font file.

23. The system of claim 21, wherein modifying the font file includes removing a portion of a table from the font file.

24. The system of claim 21, wherein in modifying the font file includes removing a portion of one of a kerning table and a glyph positioning table.

25. The system of claim 16, wherein sending the font information includes sending a file executable by the asset presenter that contains instructions for adjusting the spacing between the adjacent font characters present in content of the asset.

26. The system of claim 25, wherein the executable filed is produced by a font service provider.

27. The system of claim 16, wherein the font information sent to the computing device to allow the spacing of the font characters present in the content of the asset to be adjusted is extracted by a font service provider.

28. The system of claim 16, wherein the sent font information includes one or more operations with information that identify font characters present in the content of the asset.

29. The system of claim 16, wherein the sent font information includes one or more operations associated with groups of font characters having similar geometry.

30. The system of claim 16, wherein the asset presenter includes one of a web browser, a web-based application and a web view application.

31. One or more computer readable media storing instructions that are executable by a processing device, and upon such execution cause the processing device to perform operations comprising:
receiving information that identifies an asset presenter being executed by a computing device;
based on the identity of the asset presenter, determining whether the asset presenter is capable of adjusting the spacing between adjacent font characters present in content of an asset provided across one or more networks; and
in response to the determination, sending font information to the computing device to allow the spacing of the adjacent font characters present in the content of the asset to be adjusted for presentation by the computing device.

32. The computer readable media of claim 31, wherein the determination is based upon information about the asset presenter accessed from a database.

33. The computer readable media of claim 31, wherein the determination is based upon a comparison using a content presentation produced by the asset presenter.

34. The computer readable media of claim 31, wherein the determination is based upon a comparison of a content presentation produced by the asset presenter and a content presentation produced by a font service provider.

35. The computer readable media of claim 31, wherein sending font information includes sending a font file to the computing device.

36. The computer readable media of claim 31, wherein sending font information includes modifying a font file prior to sending the modified font file to the computing device.

37. The computer readable media of claim 36, wherein modifying the font file includes removing a portion of the font file.

38. The computer readable media of claim 36, wherein modifying the font file includes removing a portion of a table from the font file.

39. The computer readable media of claim 36, wherein in modifying the font file includes removing a portion of one of a kerning table and a glyph positioning table.

40. The computer readable media of claim 31, wherein sending the font information includes sending a file executable by the asset presenter that contains instructions for adjusting the spacing between the adjacent font characters present in content of the asset.

41. The computer readable media of claim 40, wherein the executable filed is produced by a font service provider.

42. The computer readable media of claim 31, wherein the font information sent to the computing device to allow the spacing of the font characters present in the content of the asset to be adjusted is extracted by a font service provider.

43. The computer readable media of claim 31, wherein the sent font information includes one or more operations with information that identify font characters present in the content of the asset.

44. The computer readable media of claim 31, wherein the sent font information includes one or more operations associated with groups of font characters having similar geometry.

45. The computer readable media of claim 31, wherein the asset presenter includes one of a web browser, a web-based application and a web view application.

46. A computer-implemented method comprising:
receiving information that represents font characters and spacing of adjacent font characters;
extracting the information that represents the spacing of the adjacent font characters from the received information;
using the extracted information to produce an executable file that contains instructions for adjusting the spacing between adjacent font characters present in content of an asset; and
sending the executable file to a computing device for spacing the adjacent font characters of the asset content for presentation by the computing device.

47. The computer-implemented method of claim 46, wherein the executable filed is produced by a font service provider.

48. The computer-implemented method of claim 46, wherein the information is extracted from a kerning table or a glyph positioning table.

49. The computer-implemented method of claim 46, wherein sending font information includes modifying a font file prior to sending the modified font file to the computing device.

50. The computer-implemented method of claim 49, wherein modifying the font file includes removing a portion of the font file.

51. The computer-implemented method of claim 49, wherein modifying the font file includes removing a portion of a table from the font file.

52. The computer-implemented method of claim 49, wherein in modifying the font file includes removing a portion of one of a kerning table and a glyph positioning table.

53. The computer-implemented method of claim 46, wherein the sent font information includes one or more operations with information that identify font characters present in the content of the asset.

54. The computer-implemented method of claim 46, wherein the sent font information includes one or more operations associated with groups of font characters having similar geometry.

55. The computer-implemented method of claim 46, wherein the asset presenter includes one of a web browser, a web-based application and a web view application.

56. A system comprising:
a computing device comprising:
a memory configured to store instructions; and
a processor to execute the instructions to perform operations comprising:
receiving information that represents font characters and spacing of adjacent font characters;
extracting the information that represents the spacing of the adjacent font characters from the received information;
using the extracted information to produce an executable file that contains instructions for adjusting the spacing between adjacent font characters present in content of an asset; and
sending the executable file to another computing device for spacing the adjacent font characters of the asset content for presentation by the other computing device.

57. The system of claim 56, wherein the executable filed is produced by a font service provider.

58. The system of claim 56, wherein the information is extracted from a kerning table or a glyph positioning table.

59. The system of claim 56, wherein sending font information includes modifying a font file prior to sending the modified font file to the computing device.

60. The system of claim 59, wherein modifying the font file includes removing a portion of the font file.

61. The system of claim 59, wherein modifying the font file includes removing a portion of a table from the font file.

62. The system of claim 59, wherein in modifying the font file includes removing a portion of one of a kerning table and a glyph positioning table.

63. The system of claim 56, wherein the sent font information includes one or more operations with information that identify font characters present in the content of the asset.

64. The system of claim 56, wherein the sent font information includes one or more operations associated with groups of font characters having similar geometry.

65. The system of claim 56, wherein the asset presenter includes one of a web browser, a web-based application and a web view application.

66. One or more computer readable media storing instructions that are executable by a processing device, and upon such execution cause the processing device to perform operations comprising:
receiving information that represents font characters and spacing of adjacent font characters;
extracting the information that represents the spacing of the adjacent font characters from the received information;
using the extracted information to produce an executable file that contains instructions for adjusting the spacing between adjacent font characters present in content of an asset; and
sending the executable file to a computing device for spacing the adjacent font characters of the asset content for presentation by the computing device.

67. The computer readable media of claim 66, wherein the executable filed is produced by a font service provider.

68. The computer readable media of claim 66, wherein the information is extracted from a kerning table or a glyph positioning table.

69. The computer readable media of claim 66, wherein sending font information includes modifying a font file prior to sending the modified font file to the computing device.

70. The computer readable media of claim 69, wherein modifying the font file includes removing a portion of the font file.

71. The computer readable media of claim 69, wherein modifying the font file includes removing a portion of a table from the font file.

72. The computer readable media of claim 69, wherein in modifying the font file includes removing a portion of one of a kerning table and a glyph positioning table.

73. The computer readable media of claim 66, wherein the sent font information includes one or more operations with information that identify font characters present in the content of the asset.

74. The computer readable media of claim 66, wherein the sent font information includes one or more operations associated with groups of font characters having similar geometry.

75. The computer readable media of claim 66, wherein the asset presenter includes one of a web browser, a web-based application and a web view application.
